(19) United States
(12) Patent Application Publication
(10) Pub. No.: US 2006/0097952 A1
(43) Pub. Date: May 11, 2006

(54) HIGH-GAIN DUAL-BAND ANTENNA

(75) Inventors: Churng-Jou Tsai, TAIPEI (TW); Woody Huang, TAIPEI (TW)

Correspondence Address: ANTENNIQUES CORP. LTD., P. O. BOX 108-00403, TAIPEI, TW

(73) Assignees: ANTENNIQUES CORP. LTD., SHULIN CITY, TAIPEI HSIEN. (TW); RUNTOP INC., KUEISHAN INDUSTRIAL PARK, TAOYUAN CITY. (TW)

(21) Appl. No.: 10/904,044

(22) Filed: Oct. 21, 2004

(51) Int. Cl. H01Q 9/30

(52) U.S. Cl. 343/900

(57) ABSTRACT

A high-gain dual-band antenna includes a resonator holder holding a resonator, which is formed of a metal sleeve, a metal barrel axially spaced from the metal sleeve at a distance, and a metal wire conductor connected to and spaced from the inside wall of the metal barrel, a inductor shell capped on the resonator holder to protect the resonator, and a signal line inserted through the resonator holder with a tubular braided conducting layer connected to the metal sleeve and a center conductor soldered to the metal barrel.

### BACKGROUND OF THE INVENTION

1. Field of the Invention

The present invention relates to an antenna and more particularly, to a high-gain dual-band antenna, which has the metal sleeve and metal barrel of the resonator axially spaced at a distance and respectively connected to the tubular braided conducting layer and center conductor of the signal line to increase the gain value without reducing the bandwidth of the high band and the low band.

2. Description of the Related Art

During the World War II, wireless networks were used as important communication systems. US arm forces transmitted data in the form of an encoded radio signal. For transmitting these data, US arm forces developed a wireless data transmission technology. In recent years, a variety of wireless communication products have been continuously developed to help communication between people at distance. Following fast development of the Internet and communication technology, diversification of communication services and monolithic systems, communication industry integration and communication technology integration become inevitable. In consequence, a variety of high-tech products are developed. The development of these high-tech products, such as mobile telephone, PDA (Personal Data Assistant), GPS (Global Positioning System), and etc. are in a revolution toward light, thin, short and small. For efficient working, high-tech products may be combined with communication technology. An early design of antenna can only receive wireless signal of a particular bandwidth. In order to improve this problem, antennas with resonator for receiving signals from different bandwidths are developed. FIG. 6 shows a multi-frequency antenna according to the prior art. As illustrated, the antenna comprises a holder base A holding a coaxial cable A1, a metal wire conductor B axially forwardly extended from the coaxial cable A1, and a resonator C covered on the connection area between the coaxial cable A1 and the metal wire conductor B to enhance the gain value. The metal wire conductor B has two coiled portions B1 and B2 connected in series. The two oiled portions B1 and B2 have different pitches and diameters for receiving signals of different bandwidths. This design of multi-frequency antenna is still not satisfactory in function. Because the metal wire conductor B has two coiled portions B1 and B2 connected in series, it requires much longitudinal installation space in an electronic product (for example, network exchanger, network card). Therefore, this design does not satisfy the market demand for physical measurements—light, thin, short, and small. Further, because the metal wire conductor has a certain length and is suspended on the outside, it tends to be deformed by an external body during transportation. Further, the use of the resonator C to improve the gain value relatively reduces the bandwidth.

### SUMMARY OF THE INVENTION

The present invention has been accomplished under the circumstances in view. It is therefore the main object of the present invention to provide a high-gain dual-band antenna, which satisfies the market demand for physical measurements—light, thin, short, and small. It is another object of the present invention to provide a high-gain dual-band antenna, which well protects the resonator against hitting by an external body accidentally, preventing deformation of the resonator during transportation. To achieve these and other objects of the present invention, the high-gain dual-band antenna comprises a resonator holder, a metal resonator connected to the resonator holder for receiving signals from different bandwidths, the metal resonator comprising a metal sleeve, a metal barrel axially arranged in line with the metal sleeve and spaced from the metal sleeve at a predetermined distance, and a metal wire conductor connected to and suspended in the metal barrel and spaced from the inside wall of the metal barrel at a distance, a inductor shell capped on the resonator holder to protect the resonator, and a signal line inserted through the resonator holder with a tubular braided conducting layer connected to the metal sleeve and a center conductor soldered to the metal barrel.

### BRIEF DESCRIPTION OF THE DRAWINGS

FIG. 1 is an exploded view of high-gain dual-band antenna according to the present invention.

FIG. 2 is a sectional exploded view of the high-gain dual-band antenna according to the present invention.

FIG. 3 is an elevational view of the high-gain dual-band antenna according to the present invention.

FIG. 4 is standing wave ratio chart obtained from a use of the high-gain dual-band antenna according to the present invention.

FIG. 5 is a return loss chart obtained from a use of the high-gain dual-band antenna according to the present invention.

FIG. 6 is a side view of a dual-band antenna according to the prior art.

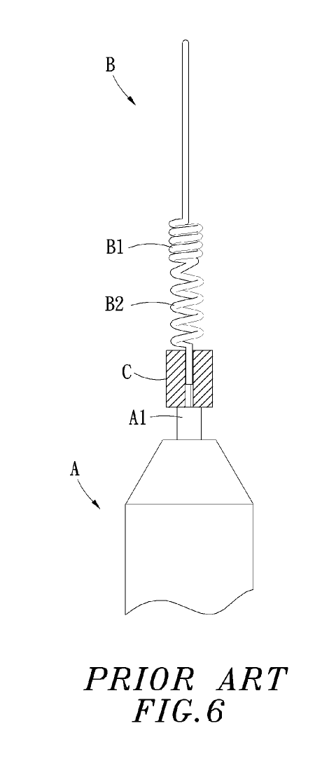

### DETAILED DESCRIPTION OF THE EMBODIMENT

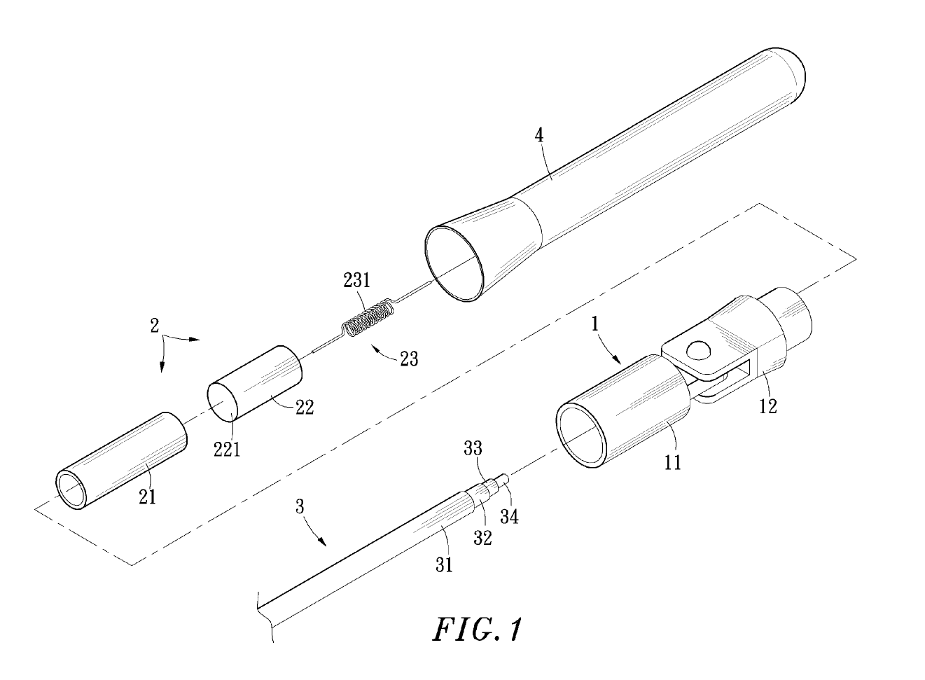

Referring to FIG. 1, a high-gain dual-band antenna in accordance with the present invention is shown comprised of a resonator holder 1, a resonator 2, a signal line 3, and an inductor shell 4.

The resonator holder 1 is an electrically insulative member adapted to support the resonator 2, comprising a holder base 12 and a mounting base 11. The holder base 12 is coupled to the mounting base 11 and rotatable in axial direction relative to the mounting base 11.

The resonator 2 comprises a metal sleeve 21, a metal barrel 22, and a metal wire conductor 23. The metal sleeve 21 and the metal barrel 22 are axially aligned in a line and spaced from each other at a predetermined distance. The metal barrel 21 has a close bottom end providing a bonding face 221. The metal wire conductor 23 has a coiled portion 231.

The signal line 3 is a coaxial cable comprising an outer insulative layer 31, a tubular braided conducting layer 32, an inner insulative layer 33, and a center conductor 34. The center conductor 34 is covered within the inner insulative layer 33. The tubular braided conducting layer 32 is covered on the periphery of the inner insulative layer 33 within the outer insulative layer 31.

The inductor shell 4 is a hollow, cylindrical, electrically insulative cover member.

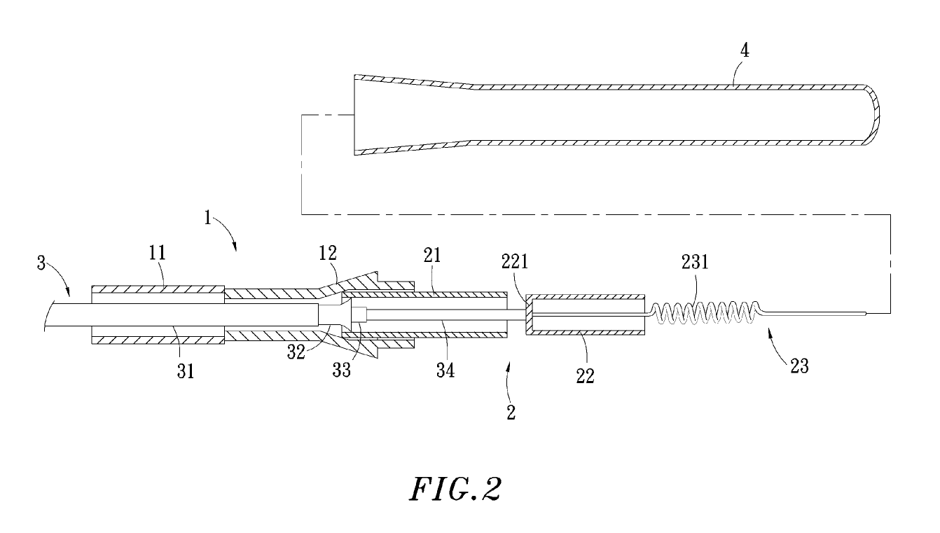

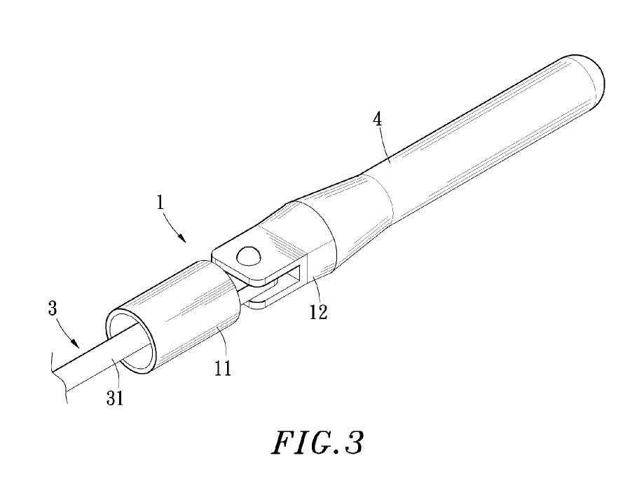

Referring to FIGS. 2 and 3 and FIG. 1 again, during assembly, the metal sleeve 21 of the resonator 2 is connected to the holder base 12 of the resonator holder 1, and then the signal line (coaxial cable) 3 is inserted in proper order through the mounting base 11, the holder base 12 and the metal sleeve 21, and then the center conductor 34 and tubular braided conducting layer 32 of the signal line (coaxial cable) 3 are respectively soldered to the bonding surface 221 of the metal barrel 22 and the metal sleeve 21, keeping the bonding surface 221 of the metal barrel 22 in line with the metal sleeve 21 and spaced from the metal sleeve 21 at a distance, and then the metal wire conductor 23 is axially fixedly connected to the metal barrel 22 and spaced from the inside wall of the metal barrel 22 at a distance with the coiled portion 231 suspended outside the metal barrel 22, and then the inductor shell 4 is capped on the holder base 12 of the resonator holder 1 to protect the resonator 2 on the inside.

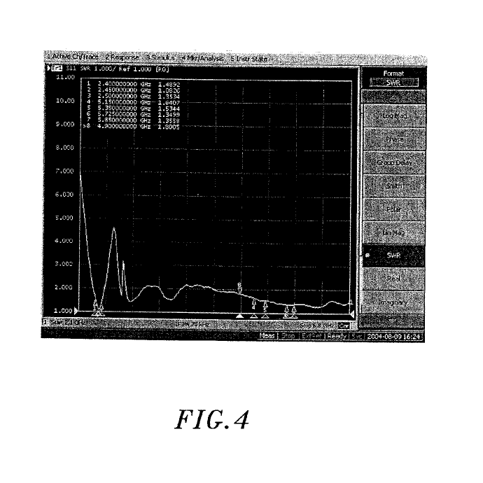

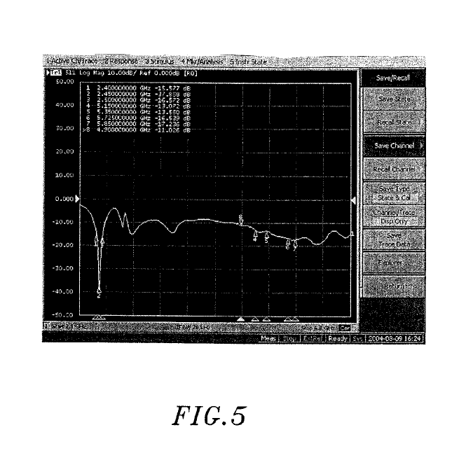

FIGS. 4 and 5 show a standing wave ratio chart and a return loss chart obtained from a use of the high-gain dual-band antenna of the present invention. As stated above, the metal barrel 22 is kept axially spaced from the metal sleeve 21 at a predetermined distance (see FIGS. 1˜3), therefore the resonator 2 can produce a low frequency resonance at the bandwidth within about 2.4 GHz˜2.5 GHz and a high frequency resonance at the bandwidth within about 4.9 GHz˜6 GHz, and the standing wave ratio between the low frequency resonance and high frequency resonance can be maintained below a certain value, thereby obtaining a stable signal. Further, because the metal wire conductor 23 of the resonator 2 is suspended in the metal barrel 22 and spaced from the inside wall of the metal barrel 22 at a distance, therefore the gain value is greatly increased without reducing the bandwidth of the low band and the high band. By means of the signal line (coaxial cable) 3 to transmit signal to an electronic product and the inductor shell 4 to shield the resonator 2, the bandwidth of the low band and the high band are effectively amplified.

Further, the distance between the metal sleeve 21 and the bonding surface 221 of the metal barrel 22 is preferably set within 1/10λ˜ 1/21λ of the high band's center carrier when the antenna is used for a high frequency application. The metal sleeve 21, the metal barrel 22 and the metal wire conductor 23 are preferably made of copper. The wall thickness of the metal barrel 22 is preferably set at about 3 mm.

The indicated above, the invention has the wire conductor 23 of the resonator 2 spaced from the inside wall of the metal barrel 22 at a distance to increase the gain value without reducing the bandwidth of the high band and the low band so that the antenna can receive signals of different frequencies. Further, because the holder base 12 is pivotally coupled to the mounting base 11, the user can adjust the azimuth of the antenna during use. Further, the inductor shell 4 protects the resonator 2 against deformation due to hitting of an external object or vibration by an external force accidentally, thereby increasing the bandwidth of the low band and the high band.

In general, the invention has the metal barrel axially spaced from the metal sleeve at a distance and the metal wire conductor suspending in the metal barrel and spaced from the inside wall of the metal barrel at a distance so as to greatly increase the gain value without reducing the bandwidth of the low band and the high band. The design of the present invention also effectively shortens the length of the antenna, satisfying the market demand for physical measurements—light, thin, short, and small. Further, the protection of the inductor shell prevents deformation of the resonator during transportation.

A prototype of high-gain dual-band antenna has been constructed with the features of FIGS. 1˜5. The high-gain dual-band antenna functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A high-gain dual-band antenna comprising a resonator holder; and a metal resonator connected to said resonator holder for receiving signals, said metal resonator comprising a metal sleeve connected to said resonator holder;
wherein said metal resonator further comprises a metal barrel axially arranged in line with said metal sleeve and spaced from said metal sleeve at a predetermined distance, and a metal wire conductor connected to and suspended in said metal barrel and spaced from the inside wall of said metal barrel at a distance.

2. The high-gain dual-band antenna as claimed in claim 1, wherein the distance between said metal sleeve and said metal barrel is about within 1/10λ˜ 1/21λ of the high band's center carrier.

3. The high-gain dual-band antenna as claimed in claim 1, wherein said metal barrel has a wall thickness at about 3 mm.

4. The high-gain dual-band antenna as claimed in claim 1, further comprising a signal line inserted through said resonator holder and said metal sleeve of said resonator, said signal line being formed of a coaxial cable comprising an outer insulative layer, a tubular braided conducting layer, an inner insulative layer and a center conductor, said center conductor being covered within said inner insulative layer and soldered to a bottom end of said metal barrel, said tubular braided conducting layer being covered on the periphery of said inner insulative layer within said outer insulative layer and connected to said metal sleeve.

5. The high-gain dual-band antenna as claimed in claim 1, wherein said metal sleeve, said metal barrel and said metal wire conductor are respectively made of copper.

6. The high-gain dual-band antenna as claimed in claim 1, wherein said metal wire conductor has a coiled portion suspended outside said metal barrel.

7. The high-gain dual-band antenna as claimed in claim 1, wherein said resonator holder comprises a mounting base, and a holder base pivotally coupled to said mounting base and adapted to hold said metal sleeve.

8. The high-gain dual-band antenna as claimed in claim 1, further comprising an electrically insulative inductor shell capped on said resonator holder to protect said resonator on the inside.
